(19) United States
(12) Patent Application Publication
(10) Pub. No.: US 2005/0053736 A1
(43) Pub. Date: Mar. 10, 2005

(54) Cationic colloidal dispersion polymers for ink jet coatings

(76) Inventors: G. Frederick Hutter, Charleston, SC (US); Camille K. Stebbins, Charleston, SC (US)

Correspondence Address: MEADWESTVACO CORPORATION, REGIONAL OFFICE BUILDING, PO BOX 118005, CHARLESTON, SC, 29423-8005, US

(21) Appl. No.: 10/935,527

(22) Filed: Sep. 7, 2004

Related U.S. Application Data
(63) Continuation-in-part of application No. 09/803,829, filed on Mar. 12, 2001, now abandoned.

(30) Foreign Application Priority Data
Mar. 12, 2002 (EP) 02 251747.8
Mar. 11, 2002 (JP) 2002-65977

(51) Int. Cl. B41M 5/00

(52) U.S. Cl. 428/32.38

(57) ABSTRACT

This invention pertains to cationic acrylic colloidal dispersion polymers. More particularly, the invention pertains to the use of cationic acrylic colloidal dispersion polymer compositions to enhance the ink jet printability of coating formulations.

This application is a continuation-in-part of commonly assigned, co-pending U.S. patent application Ser. No. 09/803,829, filed Mar. 12, 2001 and titled “Cationic Colloidal Dispersion Polymers For Ink Jet Coatings.”

### FIELD OF INVENTION

This invention pertains to cationic acrylic colloidal dispersion polymers. More particularly, the invention pertains to the use of cationic acrylic colloidal dispersion polymer compositions to enhance the ink jet printability of coating formulations.

### BACKGROUND OF THE INVENTION

Ink jet printing is widely used to print on a variety of substrates (including paper, textiles, and plastic films). These substrates are often coated with a material that enhances their receptivity for the ink jet ink. In the case of aqueous dye-based inks, which comprise the majority of inks currently used in ink jet printing, two properties are of paramount importance. The first is an affinity for water, as the coating must absorb a large amount of water from the ink in order to obtain a print that is dry to the touch in few seconds. Ink jet ink formulations often contain over 90% water. Furthermore, the coating must maintain its physical integrity while absorbing all of this water. In other words, the receptive coating must be hydrophilic enough to absorb a large quantity of water without actually being water-soluble.

The second important property is dye fixation. The majority of aqueous ink jet inks are based on dyes rather than pigments. To obtain sharp prints with high color density, the dye molecules must be immobilized almost immediately upon contact of the ink with the substrate. Penetration of the dyes into the substrate will result in reduced color density, while lateral migration of the dye molecules will cause indistinctness in the image formed.

In order to obtain high water absorption, ink jet receptive coatings have traditionally been formulated with both hydrophilic pigments (such as silica or alumina) and hydrophilic binders. While the most commonly used hydrophilic binders are polyvinyl alcohol (PVOH) and polyvinylpyrrolidinone (PVP), other suitable natural and synthetic polymers are known in the art (e.g., gelatin, starch, polyethylene oxide (PEO), hydroxyethylcellulose, carboxymethylcellulose, and the like). Those polymers that contain hydroxyl groups (such as starch, PVOH, and PEO) are often cross-linked with a compound such as glyoxal or glutaraldehyde to render them water-insoluble while maintaining their hydrophilicity. Fully hydrolyzed polyvinyl alcohol is particularly useful because it can be dissolved in hot water and remains in solution when cooled to room temperature. When the PVOH is coated on a substrate and then dried, it will not readily redissolve in room-temperature water. However, a problem exists with use of PVOH in that PVOH has no dye trapping properties.

The dyes that are commonly employed in aqueous ink jet inks are anionic, containing sulfonic acid groups. Thus dye fixation is usually accomplished by the employment of cationic polymers, although some highly polar nonionic polymers (such as PVP and polyethyloxazoline) have a limited amount of dye fixing capability. These latter polymers fix dyes by dipolar interactions between their amide groups and the sulfonic acid groups of the dye molecules, while the cationic polymers work by the more efficient mechanism of salt formation.

The most widely used cationic dye fixative in ink jet receptive coatings is poly(diallyldimethylammonium chloride), although other water-soluble cationic polymers are known in the art. For example, U.S. Pat. No. 6,010,790 teaches the use of poly(vinylbenzylquaternary ammonium salts). Other examples of water-soluble cationic polymers are cationic starch, cationic polyvinyl alcohol, guanidine-formaldehyde resins, epichlorohydrin-polyamine condensates, and water-soluble cationic acrylic resins.

However, a problem exists with the use of both soluble dipolar polymers and soluble cationic polymers in that, unless these polymers are cross-linked in some way, their presence has a detrimental effect on the water resistance of the ink jet prints.

As an alternative to water-soluble cationic resins, cationic acrylic or styrenic latices can be used as fixatives for anionic dyes in ink jet receptive coatings. These latices behave like plastic pigments. Attaching the positive charges to the surface of a pigment particle rather than to a soluble resin greatly enhances the water resistance of the ink jet prints. However, using substantial amounts of these cationic plastic pigments in a coating also results in rheological problems, which make the coatings difficult to employ on coating machinery. Furthermore, the level of cationic charge achievable with the cationic plastic pigment may not be high enough to achieve the desired level of dye fixing.

Anionic acrylic colloidal dispersion polymeric resins are widely used in the ink and coatings industries. Such polymers are manufactured by first making an acrylic latex that contains a substantial amount of an acidic monomer (such as methacrylic acid). Usually the amount of acidic monomer is sufficient to give the polymer an acid number of about 60 to about 120. The acidic functionality of the polymer is subsequently neutralized via the employment of a base (such as sodium hydroxide, potassium hydroxide, ammonia, or a water-soluble amine). This greatly enhances the hydrophilicity of the polymer, and the latex particles first swell and then lose their discreteness. While the resulting anionic acrylic colloidal dispersion polymeric resin product appears to be clear and homogeneous on a macroscopic basis, it is actually inhomogeneous on a molecular level, having some domains that are rich in hydrophobic moieties and other domains that are rich in hydrophilic ones. If a fugitive base is employed in the neutralization, these polymer dispersions dry to form water-insoluble films.

Therefore, an object of this invention is to disclose cationic acrylic colloidal dispersion polymer compositions which behave like traditional anionic dispersions, but with the opposite electrical charge.

Another object of this invention is to disclose cationic acrylic colloidal dispersion polymer compositions which exhibit properties that allow them to be useful in producing ink jet ink printing coating formulations.

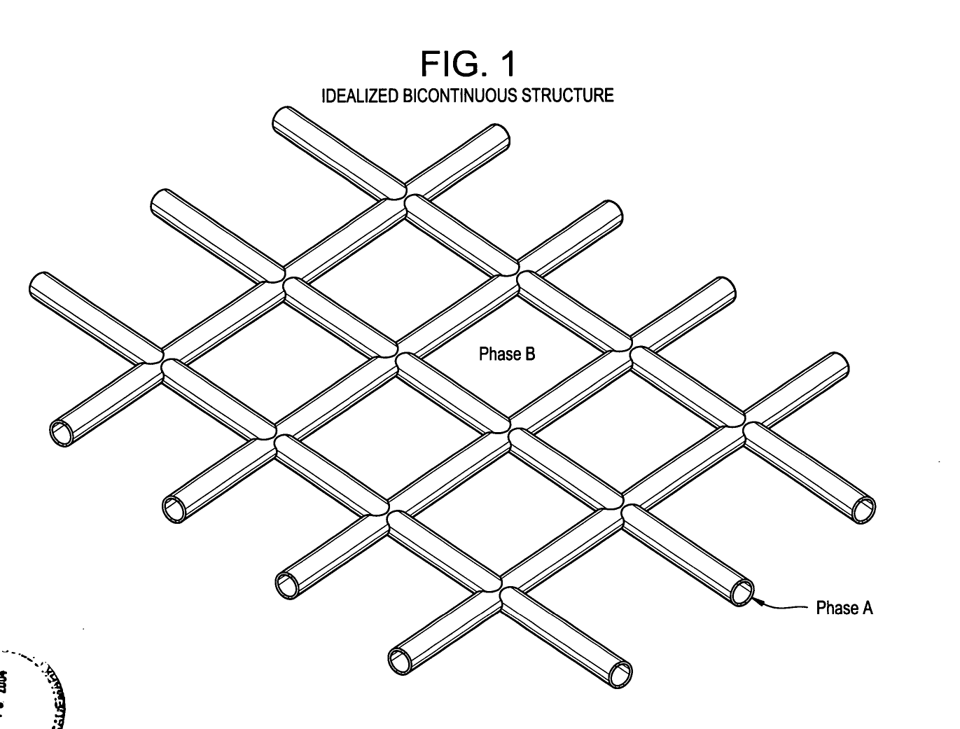

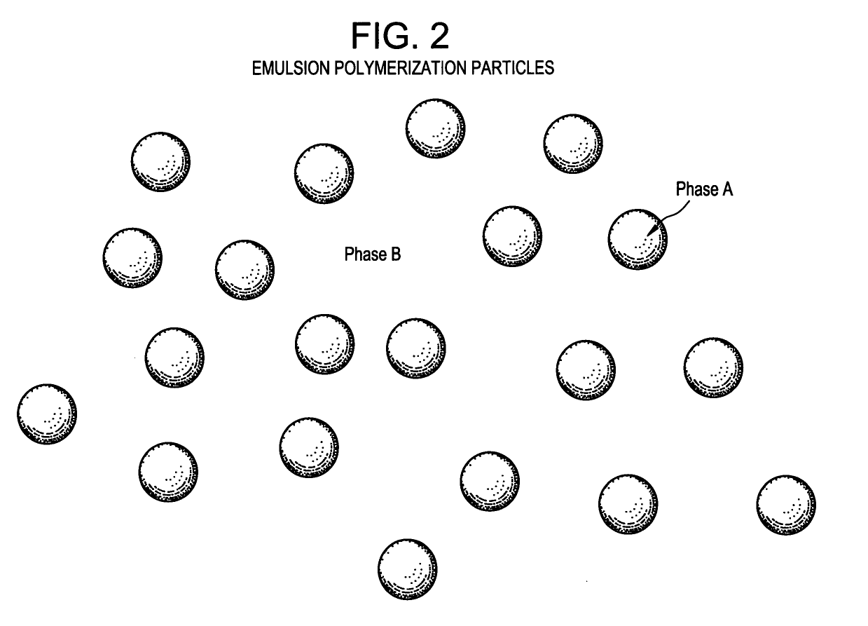

It is appreciated that many anionic (and/or cationic) acrylic colloidal dispersion polymeric resins are not necessarily suitable, for a variety of reasons, for use in ink coating applications, but may be prepared from the same or similar compounds as the invention stabilizer-containing cationic acrylic colloidal dispersion polymer compositions. Due to different reaction conditions, however, the resultant product may not be suitable for such applications. An example of such a polymer composite is that taught in U.S. Pat. No. 5,521,229 to Lu et al. The patentees teach a polymeric material having substantially nonporous bicontinuous structure in which both hydrophylic and hydrophobic polymer phases are continuous (See FIG. 1). In such a structure, the phase boundaries are pronounced and would be readily visible under an electron microscope, which is radically different from the invention stabilizer-containing cationic acrylic colloidal dispersion polymer compositions (See FIG. 2) in which the phase boundaries are indistinct. Part of the reason for the product structure disparity shown in the figures is that Lu et al. teach reaction in a microemulsion (droplet size about 10 nm), which they teach to be different from macroemulsions (droplet size about 100 nm) and miniemulsions droplet size 100-500 nm).

Thus, the stated objects of the disclosed and claimed invention may be surprisingly achieved according to the following teaching.

### SUMMARY OF THE INVENTION

The objects of this invention are met via the production of a new class of cationic polymers for ink jet receptive coatings that eliminate many of the problems involved in using cationic latices or soluble cationic polymers. These novel polymers are cationic acrylic colloidal dispersion polymer compositions.

As noted above, traditional anionic acrylic colloidal dispersion polymeric resins are produced by employing a base to neutralize the acidic functionality of the core polymer. In contrast, the cationic acrylic colloidal dispersion polymer compositions of the present invention may be described as the reverse image of such anionic dispersion resins noted in that the cationic polymer compositions contain basic functionalities which are subsequently neutralized with acid. These basic groups are provided by the employment of amine-functional monomers in the acrylic polymer. Such amine monomers may be any compound that contains both polymerizable ethylenic unsaturation and an amine group (which may be primary, secondary, or tertiary). Ink jet receptive coatings formulated with these cationic acrylic colloidal dispersion polymer compositions produce prints having enhanced definition and superior color density.

### DESCRIPTION OF THE PREFERRED EMBODIMENT

The cationic acrylic colloidal dispersion polymer compositions of the present invention, which have a continuous water phase and discontinuous polymer phase structure and where the boundaries between the phases are indistinct, comprise the free radical polymerization reaction products produced by:
(A) reacting in a macroemulsion mixture having an aqueous phase and an oil phase, said mixture comprising:
   (1) about 1.0% to about 25.0% by total weight of the mixture of a member selected from the group consisting of amine-containing ethylenically unsaturated monomers and combinations thereof;
   (2) about 10.0% to about 50.0% by total weight of the mixture of a member selected from the group consisting of acrylic esters of alcohols containing from 1 to 22 carbon atoms, methacrylic esters of alcohols containing from 1 to 22 carbon atoms, styrene, substituted styrenes, acrylonitrile, methacrylonitrile, vinyl chloride, vinylidene chloride, vinyl ethers, vinyl esters, N-vinyl amides, and combinations thereof;
   (3) up to about 8.0% by total weight of the mixture of a member selected from the group consisting of ethylenically unsaturated monomers containing at least one quaternary ammonium group and combinations thereof;
   (4) up to about 8.0% by total weight of the mixture of a member selected from the group consisting of ethylenically unsaturated monomers containing at least one hydroxyl group and combinations thereof;
   (5) up to about 8.0% by total weight of the mixture of a member selected from the group consisting of N-hydroxymethyl acrylamide, N-hydroxymethyl methacrylamide, N-hydroxymethyl-substituted acrylamide, N-hydroxymethyl-substituted methacrylamide, and combinations thereof;
   (6) up to about 4.0% by total weight of the mixture of a chain transfer agent;
   (7) about 0.5% to about 8.0% by total weight of the mixture of a surfactant selected from the group consisting of nonionic surfactants, cationic surfactants, and combinations thereof;
   (8) a catalytic amount of polymerization initiator; and
   (9) the balance of the mixture being water; to produce an emulsion polymerization product having a solids content in the range of about 25.0% to about 50.0%; and
(B) adjusting said emulsion polymerization product to a pH in the range of about 3.5 to about 7.0 to produce the cationic acrylic colloidal dispersion polymer composition.

Preferred cationic acrylic colloidal dispersion polymer compositions on the invention, which have a continuous water phase and a discontinuous oil polymer phase structure and where the boundaries between the phases are indistinct, comprise the free radical polymerization reaction products produced by:
(A) reacting in a macroemulsion mixture having a water phase and an oil phase, the mixture of monomers comprising:
   (1) about 4.0% to about 18.0% by total weight of the mixture of a member selected from the group consisting of amine-containing ethylenically unsaturated monomers and combinations thereof;
   (2) about 15.0% to about 40.0% by total weight of the mixture of a member selected from the group consisting of acrylic esters of alcohols containing from 1 to 22 carbon atoms, methacrylic esters of alcohols containing from 1 to 22 carbon atoms, styrene, substituted styrenes, acrylonitrile, methacrylonitrile, vinyl chloride, vinylidene chloride, vinyl ethers, vinyl esters, N-vinyl amides, and combinations thereof;
   (3) up to about 5.0% by total weight of the mixture of a member selected from the group consisting of ethylenically unsaturated monomers containing at least one quaternary ammonium group and combinations thereof;
   (4) up to about 5.0% by total weight of the mixture of a member selected from the group consisting of ethylenically unsaturated monomers containing at least one hydroxyl group and combinations thereof;
   (5) up to about 5.0% by total weight of the mixture of a member selected from the group consisting of N-hydroxymethyl acrylamide, N-hydroxymethyl methacrylamide, N-hydroxymethyl-substituted acrylamide, N-hydroxymethyl-substituted methacrylamide, and combinations thereof;
   (6) up to about 3.0% by total weight of the mixture of a chain transfer agent;
   (7) about 1.0% to about 5.0% by total weight of the mixture of a surfactant selected from the group consisting of nonionic surfactants, cationic surfactants, and combinations thereof;
   (8) a catalytic amount of polymerization initiator; and
   (9) the balance of the mixture being water; to produce an emulsion polymerization product having a solids content in the range of about 30.0% to about 45.0%; and
(B) adjusting said emulsion polymerization product to a pH in the range of about 4.0 to about 6.0 to produce the cationic acrylic colloidal dispersion polymer composition.

As noted above, the cationic acrylic colloidal dispersion polymer compositions of the present invention differ from traditional anionic dispersion resins in that the cationic compositions contain basic groups and are neutralized with acid. These basic groups are provided by the use of amine-functional monomers in the production of the acrylic polymer. Amine-containing ethylenically unsaturated monomers which are suitable for use in the present invention include those compounds containing both polymerizable ethylenic unsaturation and at least one amine group, which may be primary, secondary, or tertiary. Preferred amine-containing ethylenically unsaturated monomers include dimethylaminoethyl acrylate, dimethylaminoethyl methacrylate, diethylaminoethyl methacrylate, t-butylaminoethyl methacrylate, dimethylaminopropyl methacrylamide, allylamine, 2-vinylpyridine, 4-vinylpyridine, and the like. The amine-containing ethylenically unsaturated monomer comprises from about 1.0% to about 25.0%, preferably from about 4.0% to about 18.0%, by weight of the total mixture employed to produce the emulsion polymer.

In addition to amine-containing ethylenically unsaturated monomers, other functional monomers which contain reactive groups may be incorporated into the free radical polymerization reaction in order to tailor the resulting cationic acrylic colloidal dispersion polymer compositions. For example, the emulsion polymerization product (which is a latex) may be stabilized during the manufacturing process via the inclusion of up to about 8.0% (preferably up to about 5.0%) by weight of the total mixture of ethylenically unsaturated monomers containing at least one quaternary ammonium group. Quaternary ammonium monomers which are suitable for use in the present invention include those compounds which contain both polymerizable ethylenic unsaturation and at least one quaternary ammonium group. Preferred quaternary ammonium monomers include vinylbenzyltrimethylammonium chloride, methacryloyloxyethyltrimethylammonium chloride, methacrylamidopropyltrimethylammonium chloride and the like.

Where desired, the cationic acrylic colloidal dispersion polymer compositions may be given hydroxyl functionality via the inclusion of up to about 8.0% (preferably up to about 5.0%) by weight of the total mixture of hydroxyl-containing monomers. Hydroxyl-containing monomers which are suitable for use in the present invention include those monomers containing polymerizable ethyleneic unsaturation and at least one hydroxyl group. Preferred hydroxyl-containing monomers include hydroxyethyl acrylate, hydroxypropyl acrylate, hydroxybutyl acrylate, hydroxyethyl methacrylate, hydroxypropyl methacrylate, butanediol monovinyl ether, allyl alcohol, and the like. The presence of hydroxyl groups in the polymer allow it to be cross-linked with cross-linking agents that are conventionally used in coatings (such as aminoplast resins, glyoxal, glutaraldehyde, and the like).

Where desired, the cationic acrylic colloidal dispersion polymer compositions may also be made self cross-linkable via the inclusion of up to about 8.0% (preferably up to about 5.0%) by weight of the total mixture of a member selected from the group consisting of

N-hydroxymethyl acrylamide, N-hydroxymethyl methacrylamide, N-hydroxymethyl-substituted acrylamide, N-hydroxymethyl-substituted methacrylamide, and combinations thereof;

The remaining monomer component of the mixture may be any non-functional monomers which are customarily employed in the manufacture of acrylic latices. That is, from about 10.0% to about 50.0% (preferably from about 15.0% to about 40.0%) by total weight of the mixture is comprised of a member selected from the group consisting of acrylic esters of alcohols containing from 1 to 22 carbon atoms, methacrylic esters of alcohols containing from 1 to 22 carbon atoms, styrene, substituted styrenes, acrylonitrile, methacrylonitrile, vinyl chloride, vinylidene chloride, vinyl ethers, vinyl esters, N-vinyl amides, and combinations thereof.

Where desired, up to about 4.0% (preferably up to about 3.0%) by total weight of the mixture of a chain transfer agent may be employed in the polymerization reaction in order to lower the molecular weight of the emulsion polymer. Preferred chain transfer agents include dodecyl mercaptan, 2-mercaptoethanol, alkyl mercaptopropionates, mercaptoacetic acid, mercaptopropionic acid, octyl mercaptan, and the like.

Surfactants suitable for use in the emulsion polymerization reaction include members selected from the group consisting of nonionic surfactants, cationic surfactants, and combinations thereof. Preferred nonionic surfactants include ethoxylated alkylphenols, ethoxylated fatty alcohols, ethylene oxide/propylene oxide block copolymers, and the like. Preferred cationic surfactants include, but are not limited to, the following: alkyltrimethylammonium salts wherein the alkyl group contains from 8 to 22 (preferably 12 to 18) carbon atoms and the counterion of the salt is a member selected from the group consisting of chloride, bromide, methylsulfate, and ethylsulfate; alkylbenzyldimethylammonium salts wherein the alkyl group contains from 8 to 22 (preferably 12 to 18) carbon atoms and the counterion of the salt is a member selected from the group consisting of chloride, bromide, methylsulfate, and ethylsulfate; and alkylpyridinium salts wherein the alkyl group contains from 8 to 22 (preferably 12 to 18) carbon atoms and the counterion of the salt is a member selected from the group consisting of chloride, bromide, methylsulfate, and ethylsulfate. The surfactant comprises from about 0.5% to about 8.0%, preferably from about 1.0% to about 5.0%, by weight of the total mixture employed to produce the emulsion polymer.

A catalytic amount of polymerization initiator is used in the free radical polymerization reaction. The amount of initiator employed commonly comprises from about 0.1% to about 3.0% (preferably from about 0.2% to about 2.0%) by weight of the total mixture used to produce the emulsion polymer. Traditional emulsion polymerization initiators (such as thermal initiators, redox initiators, and the like) are suitable for use in the emulsion polymerization reaction. Examples of suitable thermal initiators include, but are not limited to, the following: t-butyl hydroperoxide, di-t-butyl peroxide, benzoyl peroxide, benzoyl hydroperoxide, 2,4-dichlorobenzoyl peroxide, t-butyl peracetate, azobisisobutyronitrile, and isopropyl peroxycarbonate. Examples of suitable redox initiators include cumene hydroperoxide-sodium metabisulfite, cumene hydroperoxide-iron (II) sulfate, and the like. Preferred initiators include water-soluble azo compounds (such as V-50 or VA-086 manufactured by Wako Chemicals).

Sufficient water is added to the mixture to produce an emulsion polymerization product (latex) having a solids content in the range of about 25.0% to about 50.0%. The preferred solids content for the emulsion polymerization product is in the range of about 30.0% to about 45.0%.

Neutralization of the initially formed amine-containing latex emulsion polymerization product to form the aqueous dispersion form of the polymer can be accomplished via the addition of mineral acids (such as nitric or hydrochloric acids) or organic acids (such as water-soluble carboxylic acids or water-soluble sulfonic acids). It is preferred to use low molecular weight carboxylic acids such as acetic acid, propionic acid, glycolic acid, lactic acid, and the like for neutralization, as these acids will evaporate readily upon drying of the coating containing the polymer (thereby rendering the coating water-insoluble). Furthermore, carboxylic acids are less corrosive to coating equipment than are the stronger sulfonic and mineral acids.

For maximum effectiveness as a coating binder, the pH of the neutralized cationic acrylic colloidal dispersion polymer composition should be in the range of about 3.5 to about 7.0, preferably from 4.0 to about 6.0.

The cationic acrylic colloidal dispersion polymer compositions of the present invention are superior ink jet receptive coatings. Such ink jet receptive coatings can be employed to produce ink jet printable products via the process of coating a chosen substrate on at least one side with the ink jet receptive coating. Substrates which are suitable for use in producing such ink jet printable products include paper, paperboard, wood, plastic film, metal foil, textiles, and the like. Where desired, any of the pigments traditionally used in ink jet receptive coatings can be employed in the coating provided that the pigments are compatible with a cationic binder. Such pigments include, but are not limited to, the following: silica, alumina, plastic pigments, calcium carbonate, and kaolin clay.

Where desired, other cationic and nonionic binders can be used in conjunction with the cationic acrylic colloidal dispersion polymer compositions. These binders include, but are not limited to, the following: polyvinyl alcohol, cationic polyvinyl alcohol, polyvinylpyrrolidone, cationic vinylpyrrolidone copolymers, polyethyloxazoline, cationic water-soluble acrylic polymers, nonionic water-soluble acrylic polymers, starch, cationic starch, polyethylene glycol, methylcellulose, hydroxyethylcellulose, and mixtures thereof.

In cases where the cationic acrylic colloidal dispersion polymer contains hydroxyl functionality, cross-linkers that are traditionally used with hydroxyl-functional resins can be added to the coating. Such cross-linkers include urea-formaldehyde resins, melamine-formaldehyde resins, glyoxal, glutaraldehyde, titanates, zirconium salts, and the like.

As appreciated in the art, the exact components and properties of components desired for any coating application can vary and, therefore, routine experimentation may be required to determine the optional components and proportions of components for a given application and desired properties.

The following examples are provided to further illustrate the present invention and are not to be construed as limiting the invention in any manner.

### EXAMPLE 1

Cationic acrylic colloidal dispersion polymer compositions were prepared as follows. To a round-bottomed flask fitted with a mechanical stirrer, heating mantle, and inlet tubes for monomer feed was charged 425.2 parts of deionized water and 30.0 parts of Arquad C-50 (a 50% solution of dodecyltrimethylammonium chloride in isopropyl alcohol manufactured by Akzo). Two monomer feeds were then prepared. The first was a mixture of 180.0 parts of styrene and 90.0 parts of dimethylaminoethyl methacrylate (DMAEMA). The second monomer feed was 30.0 parts of Mhoromer BM-606 (a 75% solution of methacryloyloxyethyltrimethylammonium chloride in water manufactured by R \overline{h}m America, Inc.). Fifteen percent of each monomer feed was charged to the flask along with a solution of 6.0 parts of V-50 (an azo free radical initiator manufactured by Wako Chemicals) in 15 parts of deionized water. The contents of the flask were then heated to 60° C. and the remainder of the two monomer feeds were added concurrently over three hours. When the monomer feed was complete, the temperature of the reaction was increased to 70° C. and held for one hour. Then 0.45 part of t-butyl hydroperoxide and a solution of 0.88 part of erythorbic acid in 10.0 parts of deionized water were added, and the temperature was increased to 85° C. and held for a further 2 hours. The resulting emulsion polymerization product (latex) had a solids content of 40.5%, a viscosity of 215 cP, a pH of 8.0, and an average particle size of 58 nm. The latex was converted into cationic acrylic colloidal dispersion polymer compositions via neutralization with acids. A substantial increase in viscosity accompanies this conversion as the latex particles swell and become more soluble. Neutralization with lactic acid resulted in compositions having viscosities of 595 cP at a pH of 6.6, 18,700 cP at a pH of 5.1, and 35,500 cP at a pH of 4.5. Neutralization with acetic acid resulted in compositions having viscosities of 650 cP at a pH of 6.6, 6700 cP at a pH of 5.1, and 320,000 cP at a pH of 4.5.

### EXAMPLE 2

Cationic acrylic colloidal dispersion polymer compositions may be prepared as follows. To a round-bottomed flask fitted with a mechanical stirrer, heating mantle, and inlet tubes for monomer feed was charged 425.2 parts of deionized water and 30.0 parts of Arquad C-50 (a 50% solution of dodecyltrimethylammonium chloride in isopropyl alcohol manufactured by Akzo). Two monomer feeds were then prepared. The first was a mixture of 132.0 parts of styrene and 90.0 parts of dimethylaminoethyl methacrylate (DMAEMA). The second monomer feed was 30.0 parts of Mhoromer BM-606 (a 75% solution of methacryloyloxyethyltrimethylammonium chloride in water manufactured by R \overline{h}m America, Inc.). Fifteen percent of each monomer feed was charged to the flask along with a solution of 6.0 parts of V-50 (an azo free radical initiator manufactured by Wako Chemicals) in 15 parts of deionized water. The contents of the flask were then heated to 60° C. and the remainder of the two monomer feeds were added concurrently over three hours. When the monomer feed was complete, the temperature of the reaction was increased to 70° C. and held for one hour. Then 0.45 part of t-butyl hydroperoxide and a solution of 0.88 part of erythorbic acid in 10.0 parts of deionized water were added, and the temperature was increased to 85° C. and held for a further 2 hours. The resulting emulsion polymerization product (latex) had a solids content of 39.6%, a viscosity of 50 cP, a pH of 8.4, and an average particle size of 60 nm. The latex can be converted into cationic acrylic colloidal dispersion polymer compositions via neutralization with acids to a pH in the range of about 3.5 to about 6.5.

### EXAMPLE 3

Cationic acrylic colloidal dispersion polymer compositions containing hydroxyl functionality for cross-linking can be prepared as follows. To a round-bottomed flask fitted with a mechanical stirrer, heating mantle, and inlet tubes for monomer feed was charged 425.2 parts of deionized water and 30.0 parts of Arquad C-50 (a 50% solution of dodecyltrimethylammonium chloride in isopropyl alcohol manufactured by Akzo). Two monomer feeds were then prepared. The first was a mixture of 165.0 parts of styrene and 90.0 parts of dimethylaminoethyl methacrylate (DMAEMA). The second monomer feed was 15.0 parts of hydroxyethyl methacrylate and 30.0 parts of Mhoromer BM-606 (a 75% solution of methacryloyloxyethyltrimethylammonium chloride in water manufactured by R \overline{h}m America, Inc.). Fifteen percent of each monomer feed was charged to the flask along with a solution of 6.0 parts of V-50 (an azo free radical initiator manufactured by Wako Chemicals) in 15 parts of deionized water. The contents of the flask were then heated to 60° C. and the remainder of the two monomer feeds were added concurrently over three hours. When the monomer feed was complete, the temperature of the reaction was increased to 70° C. and held for one hour. Then 0.45 part of t-butyl hydroperoxide and a solution of 0.88 part of erythorbic acid in 10.0 parts of deionized water were added, and the temperature was increased to 85° C. and held for a further 2 hours. The resulting emulsion polymerization product (latex) had a solids content of 40.3%, a viscosity of 370 cP, a pH of 8.1, and an average particle size of 97 nm. The latex can be converted into cationic acrylic colloidal dispersion polymer compositions via neutralization with acids to a pH in the range of about 3.5 to about 6.5.

### EXAMPLE 4

Self cross-linking cationic acrylic colloidal dispersion polymer compositions containing can be prepared as follows. To a round-bottomed flask fitted with a mechanical stirrer, heating mantle, and inlet tubes for monomer feed was charged 425.2 parts of deionized water and 30.0 parts of Arquad C-50 (a 50% solution of dodecyltrimethylammonium chloride in isopropyl alcohol manufactured by Akzo). Two monomer feeds were then prepared. The first was a mixture of 165.0 parts of styrene and 90.0 parts of dimethylaminoethyl methacrylate (DMAEMA). The second monomer feed was 15.0 parts of a 50% aqueous solution of N-methylolacrylamide and 30.0 parts of Mhoromer BM-606 (a 75% solution of methacryloyloxyethyltrimethylammonium chloride in water manufactured by R \overline{h}m America, Inc.). Fifteen percent of each monomer feed was charged to the flask along with a solution of 6.0 parts of V-50 (an azo free radical initiator manufactured by Wako Chemicals) in 15 parts of deionized water. The contents of the flask were then heated to 60° C. and the remainder of the two monomer feeds were added concurrently over three hours. When the monomer feed was complete, the temperature of the reaction was increased to 70° C. and held for one hour. Then 0.45 part of t-butyl hydroperoxide and a solution of 0.88 part of erythorbic acid in 10.0 parts of deionized water were added, and the temperature was increased to 85° C. and held for a further 2 hours. The resulting emulsion polymerization product (latex) had a solids content of 39.2%, a viscosity of 117 cP, a pH of 8.1, and an average particle size of 65 nm. The latex can be converted into cationic acrylic colloidal dispersion polymer compositions via neutralization with acids to a pH in the range of about 3.5 to about 6.5.

### EXAMPLE 5

An ink jet receptive paper coating containing a cationic acrylic colloidal dispersion polymer composition was prepared as follows. To a round-bottomed flask fitted with a mechanical stirrer, heating mantle, and inlet tubes for monomer feed was charged 425.2 parts of deionized water and 30.0 parts of Arquad C-50 (a 50% solution of dodecyltrimethylammonium chloride in isopropyl alcohol manufactured by Akzo). Two monomer feeds were then prepared. The first was a mixture of 180.0 parts of styrene and 90.0 parts of dimethylaminoethyl methacrylate (DMAEMA). The second monomer feed was 30.0 parts of Mhoromer BM-606 (a 75% solution of methacryloyloxyethyltrimethylammonium chloride in water manufactured by R \overline{h}m America, Inc.). Fifteen percent of each monomer feed was charged to the flask along with a solution of 6.0 parts of V-50 (an azo free radical initiator manufactured by Wako Chemicals) in 15 parts of deionized water. The contents of the flask were then heated to 60° C. and the remainder of the two monomer feeds were added concurrently over three hours. When the monomer feed was complete, the temperature of the reaction was increased to 70° C. and held for one hour. Then 0.45 part of t-butyl hydroperoxide and a solution of 0.88 part of erythorbic acid in 10.0 parts of deionized water were added, and the temperature was increased to 85° C. and held for a further 2 hours. The resulting emulsion polymerization product (latex) had a solids content of 40.5%, a viscosity of 215 cP, a pH of 8.0, and an average particle size of 58 nm. The latex was converted into cationic acrylic colloidal dispersion polymer compositions via neutralization with lactic acid to a pH of 5.0.

A coating was prepared by mixing together 60 parts on a dry basis of TRUDOT™ DPX-7817-83 (a cationic plastic pigment latex manufactured by Westvaco Corp.), 40 parts on a dry basis of CAB-O-SPERSE PG003 (a 40% aqueous dispersion of fumed alumina manufactured by Cabot Corp.), and 10 parts on a dry basis of the cationic acrylic colloidal dispersion polymer composition. The solids of the resulting ink jet receptive paper coating was adjusted to 30.4 weight-% with deionized water.

A traditional polyvinyl alcohol-based coating was produced as a comparative example. The above procedure was repeated except that the cationic colloidal dispersion polymer composition was replaced with 10 parts on a dry basis of AIRVOL 205 (a polyvinyl alcohol manufactured by Air Products, Inc.).

The cationic acrylic colloidal dispersion polymer composition coating and the coating of the comparative example were each applied to Hammermill Multipurpose paper using a No. 12 wire-wound rod. The coated sheets were then dried for 5 minutes at 110° C., and test prints were made on the dried sheets with black ink using an Epson 900 printer. The print made on the coating produced with the cationic polymer of the present invention showed much sharper definition and greater color density when compared with the print produced using the traditional polyvinyl alcohol-based coating.

Many modifications and variations of the present invention will be apparent to one of ordinary skill in the art in light of the above teachings. It is therefore understood that the scope of the invention is not to be limited by the foregoing description, but rather is to be defined by the claims appended hereto.

1. A cationic acrylic colloidal dispersion polymer composition having a continuous water phase and a discontinuous polymer phase structure and where the boundaries between the phases are indistinct comprising the free radical polymerization reaction product produced by:
(A) reacting in a macroemulsion mixture having an aqueous phase and an oil phase said mixture comprising:
(1) about 1.0% to about 25.0% by total weight of the mixture of a member selected from the group consisting of amine-containing ethylenically unsaturated monomers and combinations thereof;
(2) about 10.0% to about 50.0% by total weight of the mixture of a member selected from the group consisting of acrylic esters of alcohols containing from 1 to 22 carbon atoms, methacrylic esters of alcohols containing from 1 to 22 carbon atoms, styrene, substituted styrenes, acrylonitrile, methacrylonitrile, vinyl chloride, vinylidene chloride, vinyl ethers, vinyl esters, N-vinyl amides, and combinations thereof;
(3) up to about 8.0% by total weight of the mixture of a member selected from the group consisting of ethylenically unsaturated monomers containing at least one quaternary ammonium group and combinations thereof;
(4) up to about 8.0% by total weight of the mixture of a member selected from the group consisting of ethylenically unsaturated monomers containing at least one hydroxyl group and combinations thereof;
(5) up to about 8.0% by total weight of the mixture of a member selected from the group consisting of N-hydroxymethyl acrylamide, N-hydroxymethyl methacrylamide, N-hydroxymethyl-substituted acrylamide, N-hydroxymethyl-substituted methacrylamide, and combinations thereof;
(6) up to about 4.0% by total weight of the mixture of a chain transfer agent;
(7) about 0.5% to about 8.0% by total weight of the mixture of a surfactant selected from the group consisting of nonionic surfactants, cationic surfactants, and combinations thereof;
(8) a catalytic amount of polymerization initiator; and
(9) the balance of the mixture being water; to produce an emulsion polymerization product having a solids content in the range of about 25.0% to about 50.0%; and
(B) adjusting said emulsion polymerization product to a pH in the range of about 3.5 to about 7.0 to produce the cationic acrylic colloidal dispersion polymer composition.

2. The cationic acrylic colloidal dispersion polymer composition of claim 1 which further comprises the free radical polymerization reaction product produced by:
(A) reacting in a macroemulsion mixture having an aqueous phase and an oil phase, the mixture of monomers comprising:
(1) about 4.0% to about 18.0% by total weight of the mixture of a member selected from the group consisting of amine-containing ethylenically unsaturated monomers and combinations thereof;
(2) about 15.0% to about 40.0% by total weight of the mixture of a member selected from the group consisting of acrylic esters of alcohols containing from 1 to 22 carbon atoms, methacrylic esters of alcohols containing from 1 to 22 carbon atoms, styrene, substituted styrenes, acrylonitrile, methacrylonitrile, vinyl chloride, vinylidene chloride, vinyl ethers, vinyl esters, N-vinyl amides, and combinations thereof;
(3) up to about 5.0% by total weight of the mixture of a member selected from the group consisting of ethylenically unsaturated monomers containing at least one quaternary ammonium group and combinations thereof;
(4) up to about 5.0% by total weight of the mixture of a member selected from the group consisting of ethylenically unsaturated monomers containing at least one hydroxyl group and combinations thereof;
(5) up to about 5.0% by total weight of the mixture of a member selected from the group consisting of N-hydroxymethyl acrylamide, N-hydroxymethyl methacrylamide, N-hydroxymethyl-substituted acrylamide, N-hydroxymethyl-substituted methacrylamide, and combinations thereof;
(6) up to about 3.0% by total weight of the mixture of a chain transfer agent;
(7) about 1.0% to about 5.0% by total weight of the mixture of a surfactant selected from the group consisting of nonionic surfactants, cationic surfactants, and combinations thereof;
(8) a catalytic amount of polymerization initiator; and
(9) the balance of the mixture being water; to produce an emulsion polymerization product having a solids content in the range of about 30.0% to about 45.0%; and
(B) adjusting said emulsion polymerization product to a pH in the range of about 4.0 to about 6.0 to produce the cationic acrylic colloidal dispersion polymer composition.

3. The cationic acrylic colloidal dispersion polymer composition of claim 1 wherein the amine-containing ethylenically unsaturated monomer is a member selected from the group consisting of dimethylaminoethyl acrylate, dimethylaminoethyl methacrylate, diethylaminoethyl methacrylate, t-butylaminoethyl methacrylate, dimethylaminopropyl methacrylamide, allylamine, 2-vinylpyridine, 4-vinylpyridine, and combinations thereof.

4. The cationic acrylic colloidal dispersion polymer composition of claim 1 wherein the ethylenically unsaturated monomer containing at least one quaternary ammonium group is a member selected from the group consisting of vinylbenzyltrimethylammonium chloride, methacryloyloxyethyltrimethylammonium chloride, methacrylamidopropyltrimethylammonium chloride, and combinations thereof.

5. The cationic acrylic colloidal dispersion polymer composition of claim 1 wherein the ethylenically unsaturated monomer containing at least one quaternary ammonium group is a member selected from the group consisting of hydroxyethyl acrylate, hydroxypropyl acrylate, hydroxybutyl acrylate, hydroxyethyl methacrylate, hydroxypropyl methacrylate, butanediol monovinyl ether, allyl alcohol, and combinations thereof.

6. The cationic acrylic colloidal dispersion polymer composition of claim 1 wherein the chain transfer agent is a member selected from the group consisting of dodecyl mercaptan, 2-mercaptoethanol, alkyl mercaptopropionates, mercaptoacetic acid, mercaptopropionic acid, octyl mercaptan, and combinations thereof.

7. The cationic acrylic colloidal dispersion polymer composition of claim 1 wherein the nonionic surfactant is a member selected from the group consisting of ethoxylated alkylphenols, ethoxylated fatty alcohols, ethylene oxide/propylene oxide block copolymers, and combinations thereof.

8. The cationic acrylic colloidal dispersion polymer composition of claim 1 wherein the cationic surfactant is a member selected from the group consisting of alkyltrimethylammonium salts wherein the alkyl group contains from 8 to 22 carbon atoms and the counterion of the salt is a member selected from the group consisting of chloride, bromide, methylsulfate, and ethylsulfate; alkylbenzyldimethylammonium salts wherein the alkyl group contains from 8 to 22 carbon atoms and the counterion of the salt is a member selected from the group consisting of chloride, bromide, methylsulfate, and ethylsulfate; alkylpyridinium salts wherein the alkyl group contains from 8 to 22 carbon atoms and the counterion of the salt is a member selected from the group consisting of chloride, bromide, methylsulfate, and ethylsulfate; and combinations thereof.

9. The cationic acrylic colloidal dispersion polymer composition of claim 1 wherein the polymerization initiator comprises from about 0.1% to about 3.0% by total weight of the mixture and is a member selected from the group consisting of thermal initiators, redox initiators, and combinations thereof.

10. The cationic acrylic colloidal dispersion polymer composition of claim 9 wherein the thermal initiator is a member selected from the group consisting of hydrogen peroxide, t-butyl hydroperoxide, di-t-butyl peroxide, benzoyl peroxide, benzoyl hydroperoxide, 2,4-dichlorobenzoyl peroxide, t-butyl peracetate, azobisisobutyronitrile, isopropyl peroxycarbonate, and combinations thereof.

11. The cationic acrylic colloidal dispersion polymer composition of claim 9 wherein the redox initiator is a member selected from the group consisting of cumene hydroperoxide-sodium metabisulfite, cumene hydroperoxide-iron (II) sulfate, and combinations thereof.

12. The cationic acrylic colloidal dispersion polymer composition of claim 1 wherein the pH of the emulsion polymerization product is adjusted via addition of an acid selected from the group consisting of mineral acids, water-soluble carboxylic acids, water-soluble sulfonic acids, and combinations thereof.

13. The cationic acrylic colloidal dispersion polymer composition of claim 12 wherein the acid is a member selected from the group consisting of acetic acid, propionic acid, glycolic acid, lactic acid, and combinations thereof.

14. An ink jet receptive coating comprising the cationic acrylic colloidal dispersion polymer composition of claim 1.

15. The ink jet receptive coating of claim 14 wherein the coating further comprises a pigment.

16. The ink jet receptive coating of claim 15 wherein the pigment is a member selected from the group consisting of silica, alumina, plastic pigments, calcium carbonate, kaolin clay, and combinations thereof.

17. An ink jet printable product comprising a substrate coated on at least one side with the coating of claim 14.

18. The ink jet printable product of claim 17 where the substrate is a member selected from the group consisting of paper, paperboard, wood, plastic film, metal foil, textiles, and combinations thereof.
